(19) United States
(12) Patent Application Publication
(10) Pub. No.: US 2023/0002150 A1
(43) Pub. Date: Jan. 5, 2023

(54) RECYCLING IDENTIFICATION CONTAINER

(71) Applicant: Carlos Meneses, Flushing, NY (US)

(72) Inventor: Carlos Meneses, Flushing, NY (US)

(21) Appl. No.: 17/367,553

(22) Filed: Jul. 5, 2021

(51) Int. Cl. B65F 1/00; B65F 1/16; B07C 5/342

(52) U.S. Cl. CPC B65F 1/004; B65F 1/16; B07C 5/342; B65F 2210/152; B65F 2210/168; B65F 2210/12; B65F 2210/184; B07C 2501/0054

(57) ABSTRACT

A recycling identification container, including a main body, including a first section to store at least one trash item therein, a second section connected to the first section to store at least one recycle item therein, and a divider disposed between at least a portion of the first section and the second section to separate the first section from the second section, a cover unit removably connected to at least a portion of a first end of the main body to cover an interior of the main body, and an identification scanner disposed on and within at least a portion of the main body to scan properties of at least one item based on a predetermined algorithm to determine whether the at least one item is at least one of the at least one recycle item and the at least one trash item.

### BACKGROUND

### 1. Field

The present general inventive concept relates generally to a container, and particularly, to a recycling identification container.

### 2. Description of the Related Art

Currently, the average American generates about four and a half pounds of waste each day. From that amount, about one and a half pounds can be recycled. However, only nine percent of that waste is actually recycled. The vast majority of disposed products are often left to accumulate in landfills and/or slough off in the natural environment as litter. This increase in pollution occurs because most recycled items become contaminated when items are placed in the wrong bin and/or when a dirty food container gets unusable and are thus discarded into landfills or oceans.

Most recycle bins rely on a person to dispose of items that are known to be recyclable in the proper bin. Unfortunately, there is no guarantee that the waste is properly separated.

Therefore, there is a need for a recycling identification container that identifies and separates waste for proper disposal.

### SUMMARY

The present general inventive concept provides a recycling identification container.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a recycling identification container, including a main body, including a first section to store at least one trash item therein, a second section connected to the first section to store at least one recycle item therein, and a divider disposed between at least a portion of the first section and the second section to separate the first section from the second section, a cover unit removably connected to at least a portion of a first end of the main body to cover an interior of the main body, and an identification scanner disposed on and within at least a portion of the main body to scan properties of at least one item based on a predetermined algorithm to determine whether the at least one item is at least one of the at least one recycle item and the at least one trash item.

The main body may further include a first barrier movably disposed on at least a portion of a first end of the first section to move from closed over the first section in a first position to at least partially opened within the first section in a second position, and move from opened within the first section in the second position to closed over the first section in the first position, and a second barrier movably disposed on at least a portion of a first end of the second section to move from closed over the second section in a first position to at least partially opened within the second section in a second position, and move from opened within the second section in the second position to closed over the second section in the first position.

The cover unit may include a cover body, and a cover barrier movably disposed on at least a portion of the cover body to move from closed over an interior of the cover body in a first position to at least partially opened within the interior of the cover body in a second position, and move from opened within the interior of the cover body in the second position to closed over the interior of the cover body in the first position.

The cover unit may further include a sensor disposed within at least a portion of the cover barrier to detect movement, such that the cover barrier moves in response to the sensor detecting the movement.

The sensor may prevent the cover barrier from moving until after the identification scanner completes identifying the at least one item.

The cover barrier may display the at least one item is at least one of the at least one recycle item and the at least one trash item in response to the identification scanner completing identification of the at least one item.

The recycling identification container may further include a compactor assembly removably connected to at least a portion of a base of the first section and the second section on a second end of the main body opposite with respect to the first end to compress the at least one recycle item therein received from the second section.

The main body may further include a compactor barrier movably disposed on at least a portion of the second section to move from closed over the compactor assembly in a first position to at least partially opened within the compactor assembly in a second position, and move from opened within the compactor assembly in the second position to closed over the compactor assembly in the first position.

The compactor barrier may open in response to detecting a predetermined weight on the compactor barrier within the second section.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a sectional view of a recycling identification container, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURE, the thicknesses of lines, layers and/or regions may be exaggerated for clarity.

Accordingly, while example embodiments are capable of various modifications and alternative forms, embodiments thereof are shown by way of example in the FIGURE and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### List of Components

Recycling Identification Container 100

Main Body 110

First Section 111

Second Section 112

Divider 113

First Barrier 114

Second Barrier 115

Compactor Barrier 116

Cover Unit 120

Cover Body 121

Cover Barrier 122

Sensor 123

Identification Scanner 130

Compactor Assembly 140

Compaction Chamber 141

Compaction Unit 142

Power Button 150

Power Source 160

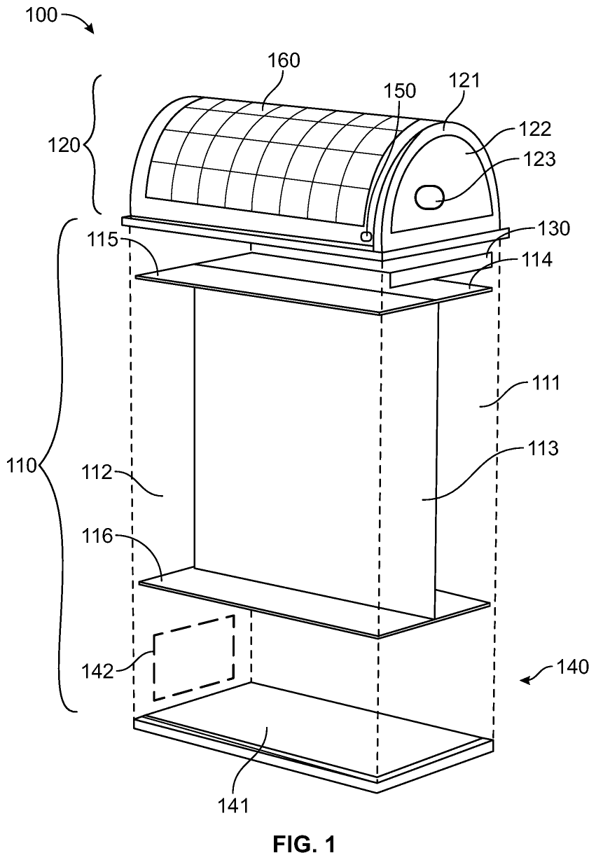

FIG. 1 illustrates a sectional view of a recycling identification container 100, according to an exemplary embodiment of the present general inventive concept.

The recycling identification container 100 may be constructed from at least one of metal, plastic, wood, ceramic, glass, and rubber, etc., but is not limited thereto.

The recycling identification container 100 may include a main body 110, a cover unit 120, an identification scanner 130, a compactor assembly 140, a power button 150, and a power source 160, but is not limited thereto.

The main body 110 may include a first section 111, a second section 112, a divider 113, a first barrier 114, a second barrier 115, and a compactor barrier 116, but is not limited thereto.

The first section 111 may be disposed within at least a portion of the main body 110. The first section 111 may store at least one trash item therein. Although the first section 111 is referred to as storing trash, it may also include recycled items that have been contaminated and unfit for recycling.

The second section 112 may be disposed within at least a portion of the main body 110 and/or connected to the first section 111. The second section 112 may store at least one recycle item therein.

The divider 113 may be disposed between at least a portion of the first section 111 and/or the second section 112. Moreover, the divider 113 may separate the first section 111 from the second section 112, such that the divider 113 may prevent items within the first section 111 and/or the second section 112 from mixing.

The first barrier 114 may be movably disposed on at least a portion of a first end of the first section 111 and/or connected to the divider 113. The first barrier 114 may move (i.e. pivot and/or rotate) from closed over the first section 111 in a first position to at least partially opened within the first section 111 in a second position. In other words, the first barrier 114 may pivot toward the first section 111 to open. As such, the first section 111 may receive the at least one trash item in response to the first barrier 114 being opened. Conversely, the first barrier 114 may move from opened within the first section 111 in the second position to closed over the first section 111 in the first position in response to the at least one trash item entering the first section 111.

The second barrier 115 may be movably disposed on at least a portion of a first end of the second section 112 and/or connected to the divider 113. The second barrier 115 may move (i.e. pivot and/or rotate) from closed over the second section 112 in a first position to at least partially opened within the second section 112 in a second position. In other words, the second barrier 115 may pivot toward the second section 112 to open. As such, the second section 112 may receive the at least one recycle item in response to the second barrier 115 being opened. Conversely, the second barrier 115 may move from opened within the second section 112 in the second position to closed over the second section 112 in the first position in response to the at least one recycle item entering the second section 112.

Optionally, the second barrier 115 may move away from the second section 112 in response to the first barrier 114 being opened to facilitate movement of the at least one trash item into the first section 111. In other words, the second barrier 115 may move up in an angled (i.e. slanted) position. Similarly, the first barrier 114 may move away from the first section 111 in response to the second barrier 115 being opened to facilitate movement of the at least one recycle item into the second section 112. As such, the first barrier 114 may move up in an angled (i.e. slanted) position.

The compactor barrier 116 may be movably disposed on at least a portion of a base of the second section 112 at a second end of the second section 112 opposite with respect to the first end of the second section 112. The compactor barrier 116 may move (i.e. pivot and/or rotate) from closed over the compactor assembly 140 in a first position to at least partially opened within the compactor assembly 140 in a second position. In other words, the compactor barrier 116 may pivot toward the compactor assembly 140 to open. Conversely, the compactor barrier 116 may move from opened within the compactor assembly 140 in the second position to closed over the compactor assembly 140 in the first position. Furthermore, the compactor barrier 116 may include a sensor, such that the compactor barrier 116 may open in response to detecting a predetermined weight on the compactor barrier 116 within the second section 116.

The cover unit 120 may include a cover body 121, a cover barrier 122, and a sensor 123, but is not limited thereto.

The cover body 121 may be removably connected to at least a portion of a first end of the main body 110. The cover body 121 may operate as a lid for the main body 110. Additionally, the cover body 121 may be semi-cylindrical in shape.

The cover barrier 122 may include a display unit (e.g., a plasma screen, an LCD screen, a light emitting diode (LED) screen, an organic LED (OLED) screen, a computer monitor, a hologram output unit, a sound outputting unit, or any other type of device that visually or aurally displays data), but is not limited thereto.

The cover barrier 122 may be movably disposed on at least a portion of the cover body 121. The cover barrier 122 may move (i.e. pivot and/or rotate) from closed over an interior of the cover body 121 in a first position to at least partially opened within the interior of the cover body 121 in a second position. Conversely, the cover barrier 122 may move from opened within the interior of the cover body 121 in the second position to closed over the interior of the cover body 121 in the first position.

The sensor 123 may be disposed within at least a portion of the cover barrier 122. Additionally, the sensor 123 may detect a presence (i.e. movement) of a user, such that the cover barrier 122 may move in response to the sensor 123 detecting the movement.

The identification scanner 130 may include a three-dimensional scanner, a laser scanner, and a photo scanner, but is not limited thereto.

The identification scanner 130 may be disposed on and/or within at least a portion of the main body 110. The identification scanner 130 may scan at least one item within a predetermined distance thereof (e.g. six inches, one foot, two feet). The identification scanner 130 may identify properties of the at least one item based on a predetermined algorithm of items that may be identified as trash and/or recycled items. Furthermore, the identification scanner 130 may identify additional items, such as contaminated items (e.g., stains, dirt, food, grease, etc.). As such, the cover barrier 122 may display the at least one item as either trash or recyclable in response to the identification scanner 130 identifying whether the at least one item is trash or recyclable. Accordingly, the cover barrier 122 may indicate whether the first section 111 or the second section 112 receives the at least one item. Also, the sensor 123 may allow the cover barrier 122 to move after the identification scanner 130 has completed categorizing the at least one item. In other words, the sensor 123 may prevent the cover barrier 122 from moving until after the identification scanner 130 has completed identifying the at least one item.

The compactor assembly 140 may include a compaction chamber 141 and a compaction unit 142, but is not limited thereto.

The compaction chamber 141 may be removably disposed and/or removably connected to at least a portion of a base of the first section 111 and/or the second section 112 at a second end of the first section 111 and/or the second section 112 opposite with respect to the first end of the first section 111 and/or the second section 112. The compaction chamber 141 may receive and/or store the at least on recycle item therein. Moreover, the compaction chamber 141 may receive the at least one recycle item from the second section 112 in response to the compactor barrier 116 being opened.

The compaction unit 142 may include a motor and a piston, but is not limited thereto.

The compaction unit 142 may compress the at least one recycle item within the compaction chamber 141. Moreover, the compaction unit 142 may reduce a volume of the at least one recycle item within the compaction chamber 141. As such, the at least one recycle item may be reduced in size and sold by the user.

The power button 150 may be disposed on at least a portion of the cover body 121. The power button 150 may turn on the main body 110, the cover unit 120, the identification scanner 130, and/or the compactor assembly 140 in response to depressing the power button a first time. Subsequently, the power button 150 may turn off the main body 110, the cover unit 120, the identification scanner 130, and/or the compactor assembly 140 in response to depressing the power button a second time.

The power source 160 may include a solar cell and a battery, but is not limited thereto.

The power source 160 may be disposed on at least a portion of the cover body 121. The power source 160 may semi-cylindrical shaped similar to the cover body 121 to maximize receiving a light source from different angles. Additionally, the power source 160 may provide power to the main body 110, the cover unit 120, the identification scanner 130, the compactor assembly 140, and/or the power button 150.

Therefore, the recycling identification container 100 may identify waste prior to disposal to ensure it is separated. Also, the recycling identification container 100 may identify the at least one item that may be recycled and prevent contamination of recycled items that end up in a landfill.

The present general inventive concept may include a recycling identification container 100, including a main body 110, including a first section 111 to store at least one trash item therein, a second section 112 connected to the first section 111 to store at least one recycle item therein, and a divider 113 disposed between at least a portion of the first section 111 and the second section 112 to separate the first section 111 from the second section 112, a cover unit 120 removably connected to at least a portion of a first end of the main body 110 to cover an interior of the main body 110, and an identification scanner 130 disposed on and within at least a portion of the main body 110 to scan properties of at least one item based on a predetermined algorithm to determine whether the at least one item is at least one of the at least one recycle item and the at least one trash item.

The main body 110 may further include a first barrier 114 movably disposed on at least a portion of a first end of the first section 111 to move from closed over the first section 111 in a first position to at least partially opened within the first section 111 in a second position, and move from opened within the first section 111 in the second position to closed over the first section 111 in the first position, and a second barrier 115 movably disposed on at least a portion of a first end of the second section 112 to move from closed over the second section 112 in a first position to at least partially opened within the second section 112 in a second position, and move from opened within the second section 112 in the second position to closed over the second section 112 in the first position.

The cover unit 120 may include a cover body 121, and a cover barrier 122 movably disposed on at least a portion of the cover body 121 to move from closed over an interior of the cover body 121 in a first position to at least partially opened within the interior of the cover body 121 in a second position, and move from opened within the interior of the cover body 121 in the second position to closed over the interior of the cover body 121 in the first position.

The cover unit 120 may further include a sensor 123 disposed within at least a portion of the cover barrier 122 to detect movement, such that the cover barrier 122 moves in response to the sensor 123 detecting the movement.

The sensor 123 may prevent the cover barrier 122 from moving until after the identification scanner 130 completes identifying the at least one item.

The cover barrier 122 may display the at least one item is at least one of the at least one recycle item and the at least one trash item in response to the identification scanner 130 completing identification of the at least one item.

The recycling identification container 100 may further include a compactor assembly 140 removably connected to at least a portion of a base of the first section 111 and the second section 112 on a second end of the main body 110 opposite with respect to the first end to compress the at least one recycle item therein received from the second section 112.

The main body 110 may further include a compactor barrier 116 movably disposed on at least a portion of the second section 112 to move from closed over the compactor assembly 140 in a first position to at least partially opened within the compactor assembly 140 in a second position, and move from opened within the compactor assembly 140 in the second position to closed over the compactor assembly 140 in the first position.

The compactor barrier 116 may open in response to detecting a predetermined weight on the compactor barrier 116 within the second section 112.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A recycling identification container, comprising:
a main body, comprising:
a first section to store at least one trash item therein,
a second section connected to the first section to store at least one recycle item therein, and
a divider disposed between at least a portion of the first section and the second section to separate the first section from the second section;
a cover unit removably connected to at least a portion of a first end of the main body to cover an interior of the main body; and
an identification scanner disposed on and within at least a portion of the main body to scan properties of at least one item based on a predetermined algorithm to determine whether the at least one item is at least one of the at least one recycle item and the at least one trash item.

2. The recycling identification container of claim 1, wherein the main body further comprises:
a first barrier movably disposed on at least a portion of a first end of the first section to move from closed over the first section in a first position to at least partially opened within the first section in a second position, and move from opened within the first section in the second position to closed over the first section in the first position; and
a second barrier movably disposed on at least a portion of a first end of the second section to move from closed over the second section in a first position to at least partially opened within the second section in a second position, and move from opened within the second section in the second position to closed over the second section in the first position.

3. The recycling identification container of claim 1, wherein the cover unit comprises:
a cover body; and
a cover barrier movably disposed on at least a portion of the cover body to move from closed over an interior of the cover body in a first position to at least partially opened within the interior of the cover body in a second position, and move from opened within the interior of the cover body in the second position to closed over the interior of the cover body in the first position.

4. The recycling identification container of claim 3, wherein the cover unit further comprises:
a sensor disposed within at least a portion of the cover barrier to detect movement, such that the cover barrier moves in response to the sensor detecting the movement.

5. The recycling identification container of claim 4, wherein the sensor prevents the cover barrier from moving until after the identification scanner completes identifying the at least one item.

6. The recycling identification container of claim 3, wherein the cover barrier displays the at least one item is at least one of the at least one recycle item and the at least one trash item in response to the identification scanner completing identification of the at least one item.

7. The recycling identification container of claim 1, further comprising:
a compactor assembly removably connected to at least a portion of a base of the first section and the second section on a second end of the main body opposite with respect to the first end to compress the at least one recycle item therein received from the second section.

8. The recycling identification container of claim 7, wherein the main body further comprises:
a compactor barrier movably disposed on at least a portion of the second section to move from closed over the compactor assembly in a first position to at least partially opened within the compactor assembly in a second position, and move from opened within the compactor assembly in the second position to closed over the compactor assembly in the first position.

9. The recycling identification container of claim 8, wherein the compactor barrier opens in response to detecting a predetermined weight on the compactor barrier within the second section.
